(19) United States
(12) Patent Application Publication
(10) Pub. No.: US 2007/0178785 A1
(43) Pub. Date: Aug. 2, 2007

(54) Anti-skid flame blocker thermal barrier

(76) Inventor: Loren M. Collins, Mount Pleasant, SC (US)

Correspondence Address: W. PETE REID;ATTORNEY AT LAW, LLC, PO BOX 13555, CHARLESTON, SC, 29422-3555, US

(21) Appl. No.: 11/490,799

(22) Filed: Jul. 20, 2006

Related U.S. Application Data
(63) Continuation-in-part of application No. 10/871,490, filed on Jun. 18, 2004, now abandoned.

(51) Int. Cl. B32B 27/12; B32B 5/02; B32B 5/24

(52) U.S. Cl. 442/101; 442/136; 442/153; 442/165; 442/168; 442/170; 442/171; 442/370; 442/374

(57) ABSTRACT

The present invention comprises a calendered low profile non-woven anti-skid flame blocking thermal barrier fabric comprising a concentration of natural fibers selected from the group consisting of cotton, flax, hemp, kenauf, and rayon capable of charring upon exposure to flame to form a char component; a concentration of synthetic fibers selected from the group consisting of polyester, polypropylene, nylon, and polyethylene, capable of melting upon exposure to flame to form a reinforcement component to provide structural integrity to the char component; a flame retardant; an anti-skid treatment applied to at least one fabric surface to confer anti-skid properties to the fabric; and a reinforced char barrier formed upon exposure to flame by the char component and the reinforcement component; the reinforcement of the char barrier being the char component embedded in the reinforcement component; the char component and reinforcement component acting together to form a reinforced char barrier to resist puncture, tear and abrasion forces; the char component and reinforcement component acting together to form a reinforced char barrier that prevents the flame and the associated heat from transferring to ignite or melt a flammable substrate.

### RELATED U.S. APPLICATION DATA

This application is a continuation-in-part of U.S. patent application Ser. No. 10/871,490, filed Jun. 18, 2004 for Apparatus and Method for Anti-skid Flame Blocker Thermal Barrier.

### BACKGROUND

This invention relates to an anti-skid flame blocker thermal barrier fabric and fiber blend that will not ignite or burn upon exposure to open flame but instead forms a reinforced char barrier that prevents a flame and the associated heat from transferring to ignite or melt a flammable substrate.

While not specifically directed to anti-skid fiber and fabric apparatus and methods, prior anti-skid or anti-slip layers have been disclosed as consisting of dipped open weave nylon (U.S. Pat. No. 6,701,556), texturized woven rayon acetate or polyester (U.S. Pat. No. 4,317,244), texturized rubber (PCT App. No. 99449761), and Velcro.RTM. attached scrim or webbing having a rubbery coating (U.S. Pat. No. 9,820,828). None of these previous patents contemplated a flame blocker thermal barrier anti-skid fabric and fiber blend.

Composite structures having multiple layers have previously been employed in an attempt to protect mattresses and mattress foundations from fire. U.S. Patent Application Publication No. 2004/0060119 represents the archetype of a composite structure employing multiple layers in an attempt to protect mattresses and mattress foundations from fire. Composite structures employing multiple layers are disadvantageous because of their increased bulk, and their introduction of a point of failure where the layers adjoin. This archetype, and its variations, do not contemplate nor disclose a unitary flame blocker thermal barrier anti-skid fabric and fiber blend.

Prior non-composite flame-retardant fabrics, while resistant to flame, are lacking in structural integrity, however, having virtually zero puncture, tear, cross direction, and machine direction strength prior to exposure to flame. Of greater concern, the flame-retardant materials produced in these previous methods are virtually reduced to dust when exposed to an open flame, having no tensile strength upon charring. These fabrics were limited in their end uses, and flame retardant materials produced by this method were used primarily in incontinent pad sheets and medical or emergency services clothing materials. Thus, fabrics such as disclosed in U.S. Pat. Nos. 6,132,476, 5,609,950, 5,766,746, and 4,151,322, are incapable of forming a reinforced char barrier that prevents a flame from igniting any flammable substrate.

Thus, there remains a need for the improvement of fire protection for mattresses, mattress foundations and upholstered seating constructions.

### SUMMARY

The present invention comprises a calendered low profile non-woven anti-skid flame blocking thermal barrier fabric comprising a concentration of natural fibers selected from the group consisting of cotton, flax, hemp, kenauf, and rayon capable of charring upon exposure to flame to form a char component; a concentration of synthetic fibers selected from the group consisting of polyester, polypropylene, nylon, and polyethylene, capable of melting upon exposure to flame to form a reinforcement component to provide structural integrity to the char component; a flame retardant; an anti-skid treatment applied to at least one fabric surface to confer anti-skid properties to the fabric; and a reinforced char barrier formed upon exposure to flame by the char component and the reinforcement component; the reinforcement of the char barrier being the char component embedded in the reinforcement component; the char component and reinforcement component acting together to form a reinforced char barrier to resist puncture, tear and abrasion forces; the char component and reinforcement component acting together to form a reinforced char barrier that prevents the flame and the associated heat from transferring to ignite or melt a flammable substrate.

The fabric may further comprise a concentration of binder fibers or powders that serve as a bonding agent. The concentration of binder fiber or powder may also be pre-treated with the flame retardant. Likewise, the individual fiber concentrations may be pre-treated with the flame retardant. Alternatively, the unbonded blended fiber concentrations and/or the bonded non-woven fibrous web may be treated with the flame retardant. The flame retardant may be applied to at least one side of the non-woven bonded flame blocker fabric. The result of the present invention is an anti-skid treated non-woven calendared fabric that forms a reinforced char barrier that is stronger than a charred non-woven highloft fabric.

### BRIEF DESCRIPTION OF THE DRAWINGS

FIG. 1 is an exploded perspective view illustrating an anti-skid flame blocker thermal barrier fabric constructed in accordance with the invention employed in a mattress foundation assembly wherein the anti-skid flame blocker thermal barrier fabric covers the top, sides, and bottom of the mattress foundation.

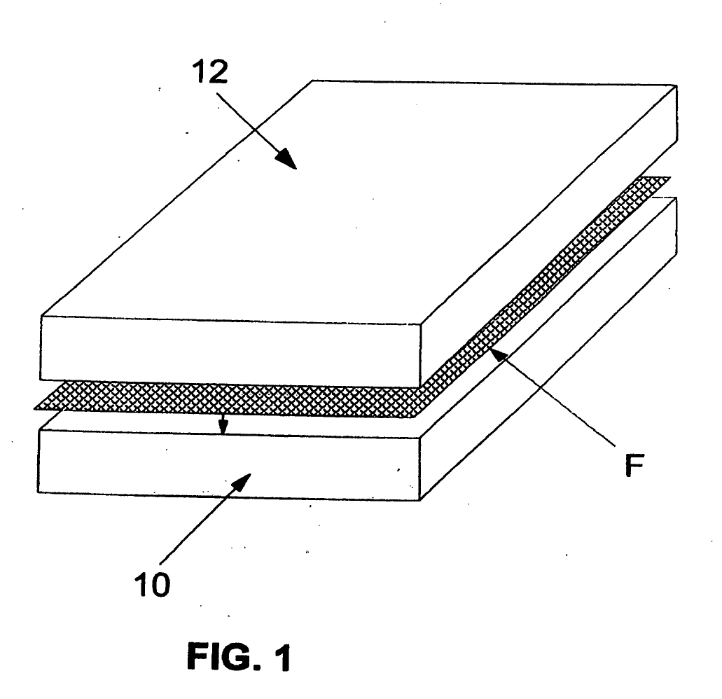

FIG. 1A is an exploded perspective view illustrating an anti-skid flame blocker thermal barrier fabric constructed in accordance with the invention employed in a mattress assembly wherein the anti-skid flame blocker thermal barrier fabric covers the top, sides, and bottom of the mattress.

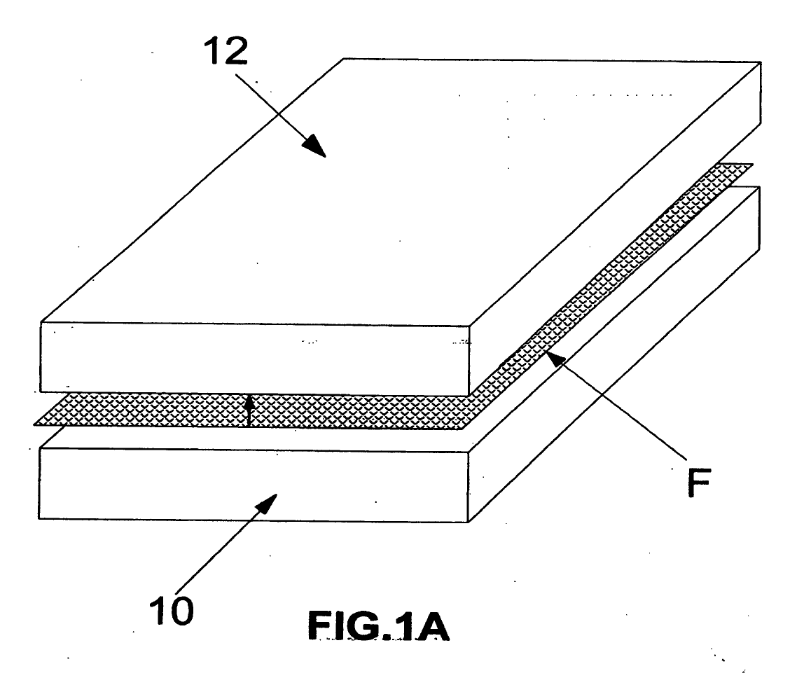

FIG. 2 is a side elevation view illustrating a mattress and mattress foundation assembly which employs the anti-skid flame blocker thermal barrier fabric constructed in accordance with the invention subjected to open flames, wherein the anti-skid flame blocker thermal barrier fabric constructed in accordance with the invention does not ignite or burn upon exposure to open flame but instead forms a reinforced char barrier that prevents the flame and the associated heat from transferring to ignite or melt any flammable substrate in the mattress and mattress foundation assembly.

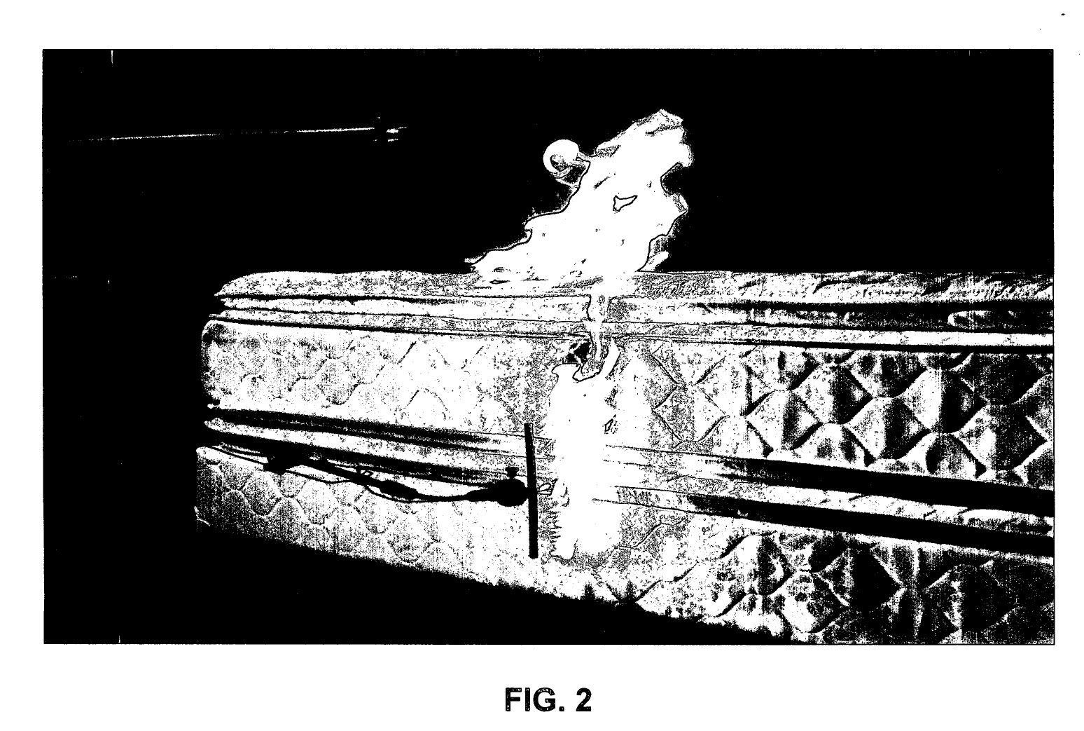

FIG. 3 is a side elevation view illustrating the mattress and mattress foundation assembly of FIG. 2 after cessation of the open flames, wherein the anti-skid flame blocker thermal barrier fabric constructed in accordance with the invention does not ignite or burn upon exposure to open flame but instead forms a reinforced char barrier that prevents the flame and the associated heat from transferring to ignite or melt any flammable substrate in the mattress and mattress foundation assembly.

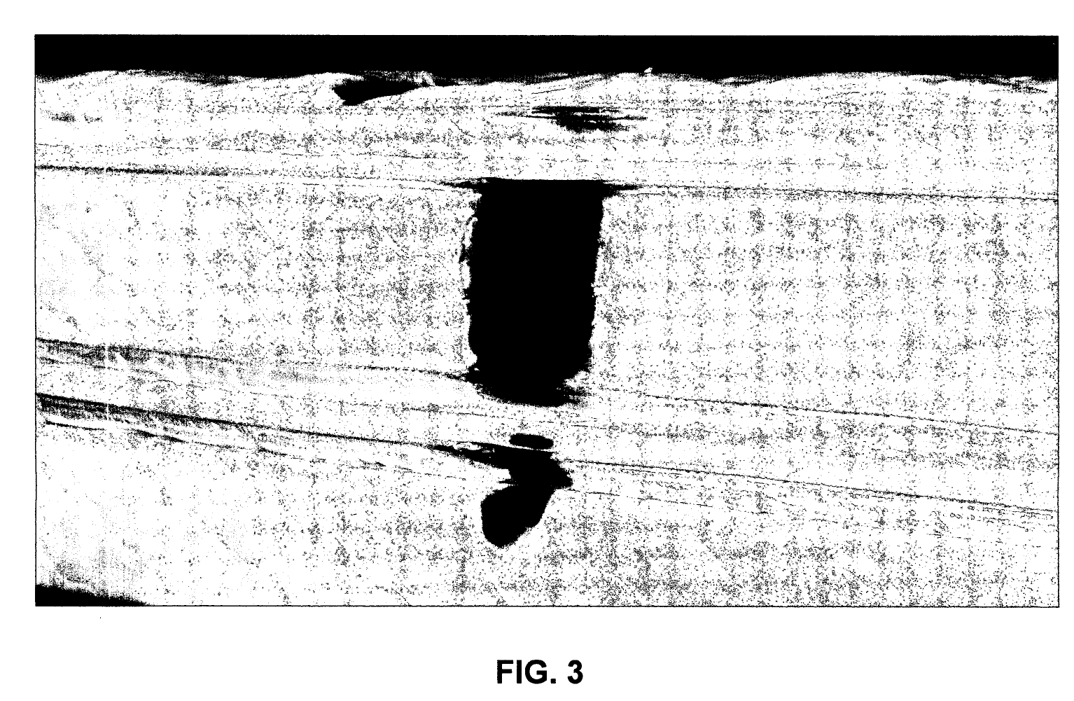

FIG. 4 is a side elevation view illustrating the mattress and mattress foundation assembly of FIG. 3, wherein the anti-skid flame blocker thermal barrier fabric constructed in accordance with the invention does not ignite or burn upon exposure to open flame but instead forms a reinforced char barrier that prevents the flame and the associated heat from transferring to ignite or melt any flammable substrate in the mattress and mattress foundation assembly.

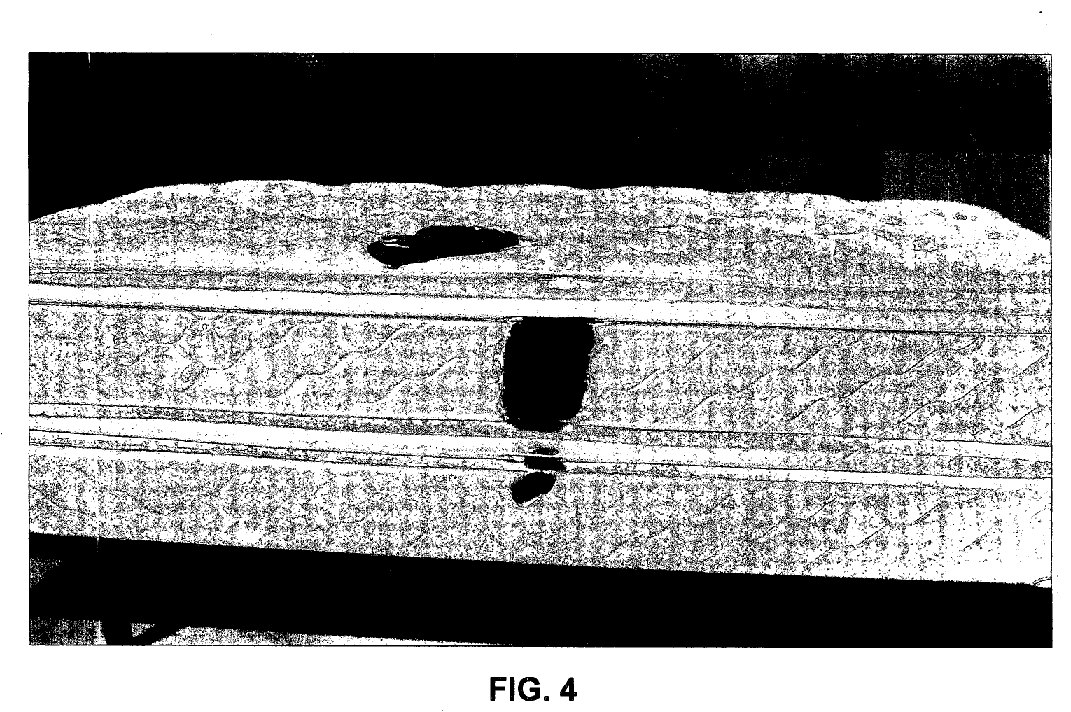

### DETAILED DESCRIPTION

Ticking: A tightly woven, very durable fabric, usually made of cotton, and used for covering mattresses, box springs, pillows, and work clothes.

Blend: Two or more fiber types combined in making yam or fabric.

Calendered Fabric: a process of pressing fabric between rollers or plates to smooth and glaze.

Calendering: a process of pressing fabric between rollers or plates to smooth and glaze. A process for finishing fabrics in which such special effects as high luster, glazing, embossing, and moir are produced.

Fabric: a sheet structure made from fibers, filaments or yarns.

Flame Blocker: a fabric that will not ignite or burn upon exposure to open flame but instead forms a reinforced char barrier that prevents a flame and the associated heat from transferring to ignite or melt a flammable substrate.

Char Barrier: a residue formed from material that has been exposed to heat and or flame, and which is no longer flammable. The char may be formed from materials that have been incompletely burned and extinguished, or from materials that do not react chemically under conditions found in a fire and are not flammable. The char barrier may also possess mechanical strength and integrity, and can act as a physical barrier to prevent flames from igniting a flammable substrate. The char barrier does not melt, drip, puncture, deform or shrink away from the ignition or heat source, nor does the char barrier after-flame, nor does the char barrier cause the ignition of adjacent materials.

Flame Retardant: a chemical applied to a fiber, applied to a fabric, or incorporated into the fiber at the time of production, which significantly reduces a fiber's and fabric's flammability.

Texturizing: Impressing a pattern into the surface of a web or fabric.

Embossing: a calendering process in which fabrics are engraved with the use of heated rollers under pressure to produce a raised design on the fabric surface.

Micrexing: the Micrex.RTM. process is a unique, uncomplicated mechanical technology to impart functional and esthetic qualities to a wide range of web structures.

Corona Treating: corona treatment exposes the surface of a treating material to an electrical discharge, or “corona.” Oxygen molecules within the discharge area break into their atomic form and are free to bond to the ends of the molecules in the material being treated, resulting in a chemically activated surface.

Plasma Treating: like corona treatment, plasma treatment is the electrical ionization of a gas. The plasma discharge creates a smooth, undifferentiated cloud of ionized gas with no visible electrical filaments. Unlike corona, plasma is created at much lower voltage levels. The rate at which electron bombardment occurs in plasma treatment is up to 100 times greater than in corona treatment. This increased cross-linking activity forces a greater ion bombardment onto the substrate surface. This results in increased etchings on the substrate's surface, and stronger bonding attributes across the length of the web. In addition to these surface reactions, plasma treatment also facilitates the use of chemical gases which can produce controlled chemical reactions on the surface as well. Plasma technology also eliminates the possibility for backside treatment. There are three key advantages of plasma treatment: 1. Longer-life treatments: Substrates that have been plasma treated hold their treatment levels far longer than corona treated surfaces. 2. Higher treat levels allow for treatment of difficult to treat surfaces. Plasma treatment is a viable alternative for a variety of substrates that corona treating is ineffective at treating. 3. Treatment of thicker substrates: While substrates that are thicker than 0.125″ usually do not respond well to the corona process, they can be plasma treated.

Binder: an adhesive material used to hold fibers together in a nonwoven structure.

Chemical bonding: part of a production route for making nonwovens; binders are applied to a web which, when dried, bond the individual fibres to form a coherent sheet.

Latex Bonding: latex bonding is a common technique whereby a web, supported on a moving belt or screen, has an adhesive resin called a binder applied to it by dipping the web into the binder and removing the excess, or by spraying, foaming or printing the latex onto the web. These methods of can also be used to color the webs by adding pigments to the binder solutions.

Thermal Bonding: part of a production route for making nonwovens in which a web, which must contain some meltable synthetic fibres, is heated by a hot gas or by calendering. The fibers melt and form inter-fiber bonds. During fusion and subsequent bonding, the low melting component softens and flows to form the bond while the high melting component maintains its fiber shape and thereby its structural integrity. Two common thermal bonding methods are through-air heating and calendaring.

Through-Air Heating: the through-air heating method uses hot air to fuse fibers within the web and on the surface of the web to make high loft, low-density fabrics. Fiber surfaces are fused to each other either by softening the fiber surface, if it melts at low temperatures, or by melting fusible additives in the form of binder powders or binder fibers. Bonding powders and fibers can be blended in with the web fibers before the web is formed or they can be sprayed on and into the web with a spray gun.

The through-air method uses hot air to fuse fibers within the web and on the surface of the web to make high loft, low density fabrics. Hot air is either blown through the web in a conveyorized oven or sucked through the web as it passes over a porous drum within which a vacuum is developed. In calender point bonding the web is drawn between heated cylinders that have an embossed pattern so that only part of the web is exposed to extreme heat and pressure. This type of calendering produces strong, low loft fabrics.

Solvent Bonding: solvent bonding can be used, for a few solvent susceptible fibers, to partly dissolve their surfaces and thereby create an adhesive of them. Removing the solvent causes resolidification of the fiber surface and bonding at the fiber crossover points.

Spunlacing (Hydroentanglement): spunlacing is a process of entangling a web of loose fibers on a porous belt or moving perforated or patterned screen to form a sheet structure by subjecting the fibers to multiple rows of fine high-pressure jets of water. Spunlacing uses high-speed jets of water to strike a web so that the fibers knot about one another. There are many different specific terms for spunlaced nonwoven, such as jet entangled, water entangled, and hydroentangled or hydraulically needled. The term, spunlace, is used more popularly in the nonwoven industry. In fact, the spunlace process can be defined as a nonwovens manufacturing system that employs jets of water to entangle fibers and thereby provide fabric integrity.

Needlepunching: a manufacturing process for which high strength, lightweight, non-woven construction fabrics are produced. These fabrics are produced by garneting fibers, entangling or inner-locking these fibers together by a series of needles and then mechanically bonding or fusing them together via heat to produce a fabric without glue or binders.

In needlepunching, barbed needles are punched through the web, hooking tufts of fibers through it and bonding it in the needlepunched areas. The needles enter and leave the web while it is trapped between two plates called a bedplate and stripper plate. The web is pulled through the needle loom by draw rolls. Sometimes needle looms with less closely spaced needles, called tackers, are used to give the web dimensional stability before it enters the main needle loom. The production of needlepunched fabrics starts with carded, air laid or spunbonded webs that are characteristically bulky.

Stitchbonding: a mechanical bonding process that uses a continuous filament or staple yarn to lock a web of unbonded fibers into a fabric with a stitch pattern.

Ultrasonic Bonding: ultrasonic bonding is similar to thermal bonding. This process can bond a single nonwoven web or laminate several webs together, including film. In this process, the nonwoven material or materials are drawn between a “horn”, which produces high frequency sound waves, and a rotary calendar, referred to as the “anvil”. The sound energy generates localized heat through mechanical vibration at the anvil's embossing points to fuse the material. The process is cool, energy efficient and often used to bond or laminate fabrics which would be affected by the other more heat intensive thermal bonding processes.

Spunbonding: spunbonding is a process by which nonwoven fabric is made by the extrusion of filaments that are then laid down in the form of a web and subsequently bonded.

Air-Doffing: air doffing involves the use of a fan or blower to remove the fibers from the carding machine where they are typically suctioned on to a moveable apron. The result is an air laid isotropic web or non-woven.

Mechanical-Doffing: mechanical doffing involves mechanically removing the fibers from the carding machine typically utilizing an apparatus having opposing card teeth to physically contact and remove the fibers from the carding machine only to deposit the fibers onto a moveable apron. The result is a carded high-loft non-woven fabric that is generally stronger in the cross direction than in the machine direction.

This invention relates to an anti-skid flame blocker thermal barrier fabric and fiber blend that will not ignite or burn upon exposure to open flame but instead forms a reinforced char barrier that prevents a flame and the associated heat from transferring to ignite or melt a flammable substrate. In a preferred embodiment the invention comprises a concentration of natural fibers A, a concentration of synthetic fibers B, a flame retardant C, and an anti-skid treatment D. The concentrations of fibers are blended and treated to form an anti-skid flame blocker thermal barrier fiber blend capable of forming an anti-skid flame blocker thermal barrier fabric F. A concentration of binder fibers or powders E may alternatively supplement the fiber blend to act as a bonding agent.

The inventive anti-skid flame blocker thermal barrier fabric and fiber blend may comprise both woven and non-woven anti-skid flame blocker thermal barrier fabrics.

The concentration of natural fibers A is preferably selected from the group consisting of vissil, cotton, hemp, kenauf, rayon, tencel, flax and wool. It is preferred that the natural fiber concentration comprise an effective amount of natural fibers or comprise an natural blend having an effective natural component to ensure that a proper char barrier is produced upon exposure to flame. Any denier or staple length of natural fiber may be used.

The concentration of synthetic fibers B is preferably selected from the group consisting of polyester, polypropylene, polyamide and polyethylene. The synthetic fiber concentration may comprise a single fiber type or a blend of different synthetic fibers, and any denier or staple length of synthetic fiber may be used.

The individual by weight fiber concentrations comprising the anti-skid flame blocker thermal barrier fiber blend are important to the flame blocking and thermal barrier properties of the fabric produced from the fiber blend. It is preferred that the fiber blend comprise up to about ninety-five percent (95%) by weight natural fiber A, and up to about eighty percent (80%) by weight synthetic fiber B. In this blend up to about thirty percent (30%) binder fiber or powder E may supplement the fiber blend. In yet another fiber blend, the blend comprises about forty to sixty percent (40-60%) by weight natural fiber A, and about twenty to fifty percent (20-50%) synthetic fiber B. In this blend up to about fifteen percent (15%) binder fiber or powder E may supplement the fiber blend.

It has been found that a fiber blend having a concentration of synthetic fibers less than twenty percent (20%) by weight produces a flame blocker fabric exhibiting marginal ability upon exposure to flame to form a reinforced char barrier to with sufficient mechanical strength and integrity to prevent a flame and the associated heat from transferring to ignite or melt any flammable substrate.

Although the above concentrations ranges are primarily established from practical considerations, empirical evidence may establish other ranges or fiber concentrations that yield an adequate reinforced char barrier capable of preventing a flame and the associated heat from transferring to ignite or melt any flammable substrate.

A concentration of binder fibers or powders E may supplement the fiber blend, and are preferably selected from the group consisting of polyester binder fiber, polyarnide binder fiber, polypropylene fibers and or cryogenically ground low melt binder powders. The binder fiber or powder concentration may comprise a single binder fiber or powder type or a blend of different binder fibers and or powders. Any denier or staple length of binder fiber may be used.

The binder fibers or binder powders E, preferably supplement the fiber blend when a low profile flame blocker fabric in accordance with the invention is desired. The addition of a concentration of binder fiber or powder to the fiber blend serves two purposes. In a preferred embodiment, the binder fiber or powder has the ability to activate or become “tacky” at a tack melting point. Secondly, upon becoming “tacky”, the binder fiber or powder acts as an adhesive that provides a strong bond between the synthetic and natural fibers.

The anti-skid flame blocker thermal barrier fabric and fiber blend constructed in accordance with the invention will not ignite or burn upon exposure to open flame, but instead forms a reinforced char barrier that prevents a flame and the associated heat from transferring to ignite or melt any flammable substrate. In accordance with the claims, the anti-skid flame blocker thermal barrier fabric and fiber blend may comprise several embodiments:

In a first embodiment, the anti-skid flame blocker thermal barrier fabric and fiber blend comprises a concentration of natural fibers A, a concentration of synthetic fibers B, a flame retardant C, and an anti-skid treatment D.

In a second embodiment, the anti-skid flame blocker thermal barrier fabric and fiber blend comprises a concentration of pretreated flame retardant natural fibers, a concentration of non-flame retardant synthetic fibers, and an anti-skid treatment.

In a third embodiment, the anti-skid flame blocker thermal barrier fabric and fiber blend comprises a concentration of non-flame retardant natural fibers, a concentration of pre-treated flame retardant synthetic fibers, and an anti-skid treatment.

In a fourth embodiment, the anti-skid flame blocker thermal barrier fabric and fiber blend comprises a concentration of pre-treated flame retardant natural fibers, concentration of pre-treated flame retardant synthetic fibers, and anti-skid treatment.

Binder fibers or powders E may supplement each of the embodiments.

In a preferred embodiment the invention comprises a concentration of natural fibers A, a concentration of synthetic fibers B, a flame retardant C, and an anti-skid treatment D. The concentrations of fibers are blended and treated to form an anti-skid flame blocker thermal barrier fiber blend capable of forming an anti-skid flame blocker thermal barrier fabric. A concentration of binder fibers or powders E may alternatively supplement the fiber blend to act as a bonding agent.

The flame retardant may be applied to the fabric, fibers, or fiber blend in a variety of configurations as reflected by the foregoing embodiments. Specifically, the individual natural and synthetic fiber concentrations may be pre-treated with the flame retardant, a blend of the natural and synthetic fiber concentrations may be treated with the flame retardant, or the flame retardant may be applied to an unbonded or bonded fibrous web. Regardless of the configuration in which the flame retardant is applied, the flame retardant is applied to at least one fiber or fabric surface.

The flame retardant is preferably applied via coating, spraying, foaming, and or dipping and squeezing the web or individual fiber concentrations to be treated. It is contemplated that more than one method of applying the flame retardant may be used.

In accordance with the invention, the anti-skid treatment of the flame blocker thermal barrier fabric may be effected mechanically, chemically, or electrically. Mechanical anti-skid treatment methods may comprise calendaring the fabric, texturizing the fabric or fibers, embossing the fabric or micrexing the fabric. The electrical anti-skid treatment may comprise corona or plasma treating the fabric.

While preferred processes for anti-skid treating of the anti-skid flame blocker thermal barrier fabric have been described using specific terms, such description is for illustrative purposes only, and it is to be understood that changes and variations may be made to the anti-skid treatment processes and methods of manufacture, without departing from the spirit or scope of the claims.

Most nonwoven webs have insufficient strength in the unbonded form. In accordance with the invention, the anti-skid flame blocker thermal barrier fabric is preferably bonded via latex bonding, thermal bonding processes such as through-air heating and calendaring, solvent bonding, mechanical bonding processes such as needlepunching, spunlacing (also called hydroentangling), or stitch bonding, ultrasonic bonding, spunbonding, air doffing, or mechanical doffing.

While preferred processes for bonding of the anti-skid flame blocker thermal barrier fabric have been described using specific terms, such description is for illustrative purposes only, and it is to be understood that changes and variations may be made to the bonding processes and methods of manufacture, without departing from the spirit or scope of the claims.

### INDUSTRIAL APPLICABILITY

The anti-skid flame blocker thermal barrier fabric constructed in accordance with the invention has broad applications within a variety of fields, especially within the fields of bedding, furniture, upholstery, blankets, comforters, and protective clothing. The examples set forth are not exhaustive, for other fields of use or specific applications not set forth below may benefit from the present invention's anti-skid flame blocker thermal barrier fabric and fiber blend that will not ignite or burn upon exposure to open flame but instead forms a reinforced char barrier that prevents a flame and the associated heat from transferring to ignite or melt any flammable substrate.

Mattress Foundations. There are three major types of mattress foundations, or “box springs” as they are sometimes called, on the market. The traditional mattress foundation is made of pine or similar wood and features seven or eight support slats beneath cardboard or fiberboard with an anti-skid, or topper covering the foundation. This type of foundation is sometimes called a “zero deflection unit”. A true box spring, by contrast, features extra-heavy-duty springs. The third type of foundation is a combination of steel and wood, sometimes called a grid foundation. Regardeless of the construction type of the mattress foundation, each is covered with an anti-skid covering fabric to prevent the mattress from skidding or sliding over the foundation.

Mattress foundations perform one of the most important roles in sleep systems. They work as shock absorbers, deflecting the weight load from the mattress. Since the ability to deflect load affects mattress durability, the box spring can help extend the life of the mattress. Because so much of the weight load is deflected to them, however, box springs can carry the greatest failure risk, especially in a fire. MORE

In a preferred embodiment the anti-skid flame blocker thermal barrier fabric constructed in accordance with the invention is employed in a mattress foundation assembly wherein the anti-skid flame blocker thermal barrier fabric covers the top, sides, and bottom of the mattress foundation. The anti-skid treatment of the flame blocker thermal barrier fabric prevents the mattress the mattress foundation supports from skidding or sliding over the mattress foundation.

It is well known that the flammability of mattress foundation material is akin to jet fuel. The anti-skid flame blocker thermal barrier fabric when covering the mattress foundation, and subjected to an open flame, does not ignite or burn, but instead forms a reinforced char barrier that prevents a flame and the associated heat from transferring to ignite or melt any flammable substrate.

Mattresses. In another embodiment, the anti-skid flame blocker thermal barrier fabric constructed in accordance with the invention is employed within a mattress or mattress foundation assembly of composite construction having an exterior ticking layer encapsulating a foam cushion layer, wherein the anti-skid flame blocker thermal barrier fabric constructed in accordance with the invention is inserted between the exterior ticking and the internal foam or other flammable materials.

It is well known that the flammability of mattress foam and mattress foundation material is akin to jet fuel. The anti-skid flame blocker thermal barrier fabric when inserted between the ticking and foam on a mattress or mattress foundation, and subjected to an open flame, does not ignite or burn, but instead forms a reinforced char barrier that prevents a flame and the associated heat from transferring to ignite or melt any flammable substrate.

Upholstered Seating. In yet another embodiment the anti-skid flame blocker thermal barrier fabric constructed in accordance with the invention is employed within an upholstered seating assembly of composite construction having an exterior ticking layer encapsulating a foam cushion layer, wherein the anti-skid flame blocker thermal barrier fabric constructed in accordance with the invention is inserted between the exterior ticking and the internal foam or other flammable materials.

It is well known that upholstery and furniture foam is similar to mattress foam having a flammability akin to jet fuel. The anti-skid flame blocker thermal barrier fabric constructed in accordance with the invention when inserted between the ticking and foam on a upholstered seating assembly, and subjected to an open flame, does not ignite or burn, but instead forms a reinforced char barrier that prevents a flame and the associated heat from transferring to ignite or melt a flammable substrate.

### EXAMPLE 1

This protocol provides a means of determining the char strength of an anti-skid treated non-woven calendared low profile fabric sample constructed in accordance with the invention after exposure to a flame ignition source under well ventilated conditions.

Summary of Test Method: A 6 inch×6 inch ant-skid treated non-woven test specimen was placed between two (2) 8 inch×8 inch stainless steel plates. Each stainless steel plate contained a 4 inch diameter hole in the center. Each non-woven sample was submitted to the fire test conditions as outlined in the California Technical Bulletin 603 testing conditions for the top burner. After exposure to the open flame via a specific gas burner, gram weights were place on top of each non-woven sample until the weights broke the web. The amount of each weight was recorded in grams. The highest and lowest number were discarded and an average of 20 samples each was calculated.

Evaluation of Burst Strength

| | | Sample | Burst | |
|---|---|---|---|---|
| Sample Type | Sample # | Wt. | Wt. | |
| Nonwoven Highloft | 1 | 5.7 | 170 | |
| Nonwoven Highloft | 2 | 5.8 | 200 | |
| Nonwoven Highloft | 3 | 5.7 | 200 | |
| Nonwoven Highloft | 4 | 5.6 | 270 | |
| Nonwoven Highloft | 5 | 5.7 | 190 | |
| Nonwoven Highloft | 6 | 5.6 | 185 | |
| Nonwoven Highloft | 7 | 5.7 | 195 | |
| Nonwoven Highloft | 8 | 5.8 | 205 | |
| Nonwoven Highloft | 9 | 5.7 | 200 | |
| Nonwoven Highloft | 10 | 5.7 | 190 | |
| Nonwoven Highloft | 11 | 5.8 | 205 | |
| Nonwoven Highloft | 12 | 5.6 | 180 | |
| Nonwoven Highloft | 13 | 5.7 | 200 | |
| Nonwoven Highloft | 14 | 5.7 | 195 | |
| Nonwoven Highloft | 15 | 5.8 | 210 | |
| Nonwoven Highloft | 16 | 5.8 | 205 | |
| Nonwoven Highloft | 17 | 5.7 | 190 | |
| Nonwoven Highloft | 18 | 5.6 | 180 | |
| Nonwoven Highloft | 19 | 5.7 | 190 | |
| Nonwoven Highloft | 20 | 5.7 | 195 | |
| Nonwoven Highloft | 21 | 5.8 | 205 | |
| Nonwoven Highloft | 22 | 5.7 | 190 | |
| Average | | 5.72 | 196 | |
| Nonwoven | 1 | 5.7 | 95 | crack in center |
| Calendared | | | | |
| NW Calendared | 2 | 5.8 | 235 | |
| NW Calendared | 3 | 5.7 | 230 | |
| NW Calendared | 4 | 5.6 | 210 | |
| NW Calendared | 5 | 5.7 | 230 | |
| NW Calendared | 6 | 5.6 | 205 | |
| NW Calendared | 7 | 5.7 | 230 | |
| NW Calendared | 8 | 5.8 | 240 | |
| NW Calendared | 9 | 5.7 | 235 | |
| NW Calendared | 10 | 5.7 | 235 | |
| NW Calendared | 11 | 5.8 | 245 | |
| NW Calendared | 12 | 5.6 | 210 | |
| NW Calendared | 13 | 5.7 | 225 | |
| NW Calendared | 14 | 5.7 | 230 | |
| NW Calendared | 15 | 5.8 | 270 | |
| NW Calendared | 16 | 5.8 | 230 | |
| NW Calendared | 17 | 5.7 | 225 | |
| NW Calendared | 18 | 5.6 | 200 | |
| NW Calendared | 19 | 5.7 | 230 | |
| NW Calendared | 20 | 5.7 | 220 | |
| NW Calendared | 21 | 5.8 | 235 | |
| NW Calendared | 22 | 5.7 | 230 | |
| Average | | 5.72 | 226 | |

226 − 196/226 × 100 = 13.3% increase

The anti-skid treated non-woven calendared fabric constructed in accordance with the invention forms a reinforced char barrier that is at least 13.3% stronger than a charred non-woven highloft fabric.

In accordance with the claims, the fiber blend may be formed into an anti-skid flame blocker thermal barrier fabric. A preferred method for manufacturing an anti-skid flame blocker thermal barrier fabric from the fiber blend comprises the following steps: blending a concentration of natural fibers capable of forming a char barrier upon exposure to flame with a concentration of synthetic fibers capable of melting upon exposure to flame for providing structural integrity to the char barrier, applying a flame retardant, and treating the fabric to confer anti-skid properties to the fabric. Binder fibers or powders may supplement the fiber blend for rendering the fabric calenderable into a low-profile anti-skid flame blocker thermal barrier fabric.

It is important the anti-skid flame blocker thermal barrier fabric be constructed utilizing a blend of natural fibers A, synthetic fibers B, a flame retardant C, and or binder fibers or powders E. It has been found that an anti-skid flame blocker thermal barrier fabric produced from a flame retardant fiber blend consisting only of a concentration of synthetic fiber (or blend of different synthetic fibers) and a concentration binder fiber melts upon exposure to flame into a non-continuous globular mass incapable of preventing the ignition or melting of a flammable substrate. On the other hand, It has been found that an anti-skid flame blocker thermal barrier fabric produced from a flame retardant fiber blend consisting only of a concentration natural fiber, with no synthetic fiber or binder component, upon exposure to flame would char and temporarily block the flame, however, the charred fibers exhibit no physical strength, practically dusting and disintegrating when stressed, failing to prevent the ignition or melting of any flammable substrate.

The anti-skid flame blocker thermal barrier fabric preferably creates a reinforced char barrier upon exposure to an open flame or resultant heat temperatures in excess of 400. degree. C. Upon exposure to flame, the concentration of natural fibers char and (approximately simultaneously) the concentration of synthetic fibers substantially melt, creating in essence, a hot liquid including synthetic fibers containing charred natural fibers. The synthetic fiber liquid reinforces the carbonized natural fibers to form a reinforced char barrier with significantly greater tensile strength and flexibility. Although the synthetic fibers are in a molten state, the charred natural fibers in contact with the synthetic slurry prevent the slurry from flowing through the char barrier or creating a gap in the char barrier for a flame to reach a flammable substrate.

The anti-skid flame blocker thermal barrier fabric is, upon exposure to flame, transformed from a fibrous structure containing distinct and separate fibers into a reinforced char barrier which no longer contains separate and distinct fibers but is thought to be a homogenous structure of natural char held and bonded together with molten synthetic material, which upon melting into a liquid flows into and encapsulates the charred natural components. This charred natural component is reinforced by the synthetic component, imparting substantial tensile, tear, and puncture strength, which imparts improved flexibility to the charred anti-skid flame blocker thermal barrier fabric, and prevents dusting or disintegration of the structure when stressed.

This is not to say the anti-skid flame blocker thermal barrier fabric constructed in accordance with the invention, when in a reinforced char barrier state, will have the puncture and tensile strength to withstand a major impact. The reinforced char barrier will, however, have substantial tensile, tear, and puncture strength, which imparts greater flexibility to the flame blocker fabric, and prevents dusting or disintegration of the structure when moderately stressed.

The char barrier formed by the anti-skid flame blocker thermal barrier fabric constructed in accordance with the invention does not swell or expand upon exposure to open flame or the resultant heat.

The fiber blend is preferably formed into an anti-skid flame blocker thermal barrier fabric of two distinct types: a high-loft non-woven fabric and a calendared low profile fabric. Each of these fabrics, upon exposure to flame, forms a reinforced char barrier that prevents the flame from igniting any flammable substrate. The difference between the fabrics is in the method of bonding, the presence and activation of a concentration of binder fibers or powders E and the process of calendaring.

The high-loft non-woven flame blocking fabric constructed in accordance with the invention gets its name by comparing its thick or high caliber state to that of a low profile condensed sheet. As a general rule, all high-loft non-woven fabric is produced by first carding the fiber blend. The fiber blend can be removed from the carding machine and formed into a non-woven fibrous web via air doffing or mechanical doffing.

The calendared low profile non-woven anti-skid flame blocker thermal barrier fabric constructed in accordance with the invention differs in construction from the high-loft as to: the method of bonding, the supplementation of a concentration of binder fiber or powder E to the fiber blend, and the process of calendaring.

In a preferred embodiment the low profile non-woven anti-skid flame blocker thermal barrier fabric is mechanically bonded and compacted preferably via needlepunching. The supplementation of the fiber blend with a concentration of binder fiber or powder is directly related to the calendaring process. The binder fiber or powder first activates or becomes “tacky” at a tack melting point specific to the binder fiber or powder. Secondly, upon becoming “tacky”, the binder fiber or powder acts as an adhesive that provides a strong inter-fiber bond between the natural and synthetic fibers. This is important to producing a low profile fabric. As the non-woven fibrous web is processed the binder fiber or powder may be activated in several ways. The binder may be activated by passing the web through a heat source such as an oven, or the binder can be activated utilizing heated calendar rolls. Whatever the method employed, to produce the low profile fabric the web must be compressed as by being calendared. Thus, using a heat source requires the separate steps of activation and calendaring, while a heated calendar roll completes the activation and compression in a unitary step.

Although the preferred fabric types of the anti-skid flame blocker thermal barrier fabric have been described using specific terms, such description is for illustrative purposes only, and it is to be understood that changes and variations may be made to the types of fabrics manufactured, without departing from the spirit or scope of the claims.

While a preferred embodiment of the invention has been described using specific terms, such description is for illustrative purposes only, and it is to be understood that changes and variations may be made to the anti-skid flame blocker thermal barrier fabric and fiber blend constructed in accordance with the invention that will not ignite or burn upon exposure to open flame, but instead forms a reinforced char barrier that prevents a flame and the associated heat from transferring to ignite or melt any flammable substrate, its parts, and methods of manufacture, without departing from the spirit or scope of the following claims.

What is claimed is:

1. A calendered low profile non-woven anti-skid flame blocking thermal barrier fabric comprising:
a concentration of natural fibers selected from the group consisting of cotton, flax, hemp, kenauf, and rayon capable of charring upon exposure to flame to form a char component;
a concentration of synthetic fibers selected from the group consisting of polyester, polypropylene, nylon, and polyethylene, capable of melting upon exposure to flame to form a reinforcement component to provide structural integrity to the char component;
a flame retardant;
an anti-skid treatment applied to at least one fabric surface to confer anti-skid properties to the fabric; and
a reinforced char barrier formed upon exposure to flame by the char component and the reinforcement component; the reinforcement of the char barrier being the char component embedded in the reinforcement component; the char component and reinforcement component acting together to form a reinforced char barrier to resist puncture, tear and abrasion forces; the char component and reinforcement component acting together to form a reinforced char barrier that prevents the flame and the associated heat from transferring to ignite or melt a flammable substrate.

2. The fabric of claim 1, further comprising a concentration of binder fibers or powders serving as a bonding agent.

3. The flame blocking fabric of claim 2, wherein the concentration of binder fiber or powder is pre-treated with the flame retardant.

4. The flame blocking fabric of claim 1, wherein the individual fiber concentrations are pre-treated with the flame retardant.

5. The flame blocking fabric of claim 1, wherein the unbonded blended fiber concentrations is treated with the flame retardant.

6. The flame blocking fabric of claim 1, wherein the bonded non-woven fibrous web is-treated with the flame retardant.

7. The non-woven flame blocking fabric of claim 1, wherein the flame retardant is applied to at least one side of the non-woven bonded flame blocker fabric.

8. The non-woven flame blocking fabric of claim 1, wherein the anti-skid treated non-woven calendared fabric forms a reinforced char barrier that is stronger than a charred non-woven highloft fabric.

9. A calendered low profile non-woven anti-skid flame blocking thermal barrier fabric comprising:
a concentration of pre-treated flame retardant natural fibers selected from the group consisting of cotton, flax, hemp, kenauf, and rayon capable of charring upon exposure to flame to form a char component;
a concentration of non-flame retardant synthetic fibers selected from the group consisting of polyester, polypropylene, nylon, and polyethylene, capable of melting upon exposure to flame to form a reinforcement component to provide structural integrity to the char component;
a concentration of binder fibers or powders;
an anti-skid treatment applied to at least one fabric surface to confer anti-skid properties to the fabric; and
a reinforced char barrier formed upon exposure to flame by the char component and the reinforcement component; the reinforcement of the char barrier being the char component embedded in the reinforcement component; the char component and reinforcement component acting together to form a reinforced char barrier to resist puncture, tear and abrasion forces; the char component and reinforcement component acting together to form a reinforced char barrier that prevents the flame and the associated heat from transferring to ignite or melt a flammable substrate.

10. A calendered low profile non-woven anti-skid flame blocking thermal barrier fabric comprising:
a concentration of non-flame retardant natural fibers selected from the group consisting of cotton, flax, hemp, kenauf, and rayon capable of charring upon exposure to flame to form a char component;
a concentration of pre-treated flame retardant synthetic fibers selected from the group consisting of polyester, polypropylene, nylon, and polyethylene, capable of melting upon exposure to flame to form a reinforcement component to provide structural integrity to the char component;
a concentration of binder fibers or powders;
an anti-skid treatment applied to at least one fabric surface to confer anti-skid properties to the fabric; and
a reinforced char barrier formed upon exposure to flame by the char component and the reinforcement component; the reinforcement of the char barrier being the char component embedded in the reinforcement component; the char component and reinforcement component acting together to form a reinforced char barrier to resist puncture, tear and abrasion forces; the char component and reinforcement component acting together to form a reinforced char barrier that prevents the flame and the associated heat from transferring to ignite or melt a flammable substrate.

11. A calendered low profile non-woven anti-skid flame blocking thermal barrier fabric comprising:
a concentration of pre-treated flame retardant natural fibers selected from the group consisting of cotton, flax, hemp, kenauf, and rayon capable of charring upon exposure to flame to form a char component;
a concentration of pre-treated flame retardant synthetic fibers selected from the group consisting of polyester, polypropylene, nylon, and polyethylene, capable of melting upon exposure to flame to form a reinforcement component to provide structural integrity to the char component;
a concentration of binder fibers or powders;
an anti-skid treatment applied to at least one fabric surface to confer anti-skid properties to the fabric; and
a reinforced char barrier formed upon exposure to flame by the char component and the reinforcement component; the reinforcement of the char barrier being the char component embedded in the reinforcement component; the char component and reinforcement component acting together to form a reinforced char barrier to resist puncture, tear and abrasion forces; the char component and reinforcement component acting together to form a reinforced char barrier that prevents the flame and the associated heat from transferring to ignite or melt a flammable substrate.

12. For use in an article of furniture having a composite structure comprising an exterior ticking layer and a foam cushion layer, wherein the improvement comprises:
a calendered low profile non-woven anti-skid flame blocking thermal barrier fabric comprising:
a concentration of natural fibers selected from the group consisting of cotton, flax, hemp, kenauf, and rayon capable of charring upon exposure to flame to form a char component;
a concentration of synthetic fibers selected from the group consisting of polyester, polypropylene, nylon, and polyethylene, capable of melting upon exposure to flame to form a reinforcement component to provide structural integrity to the char component;
a flame retardant;
an anti-skid treatment applied to at least one fabric surface to confer anti-skid properties to the fabric; and
a reinforced char barrier formed upon exposure to flame by the char component and the reinforcement component; the reinforcement of the char barrier being the char component embedded in the reinforcement component; the char component and reinforcement component acting together to form a reinforced char barrier to resist puncture, tear and abrasion forces; the char component and reinforcement component acting together to form a reinforced char barrier that prevents the flame and the associated heat from transferring to ignite or melt a flammable substrate.

13. The non-woven flame blocking fabric of claim 12, wherein the article of furniture comprises a mattress.

14. The non-woven flame blocking fabric of claim 12, wherein the article of furniture comprises a mattress foundation.

15. The non-woven flame blocking fabric of claim 12, wherein the article of furniture comprises an upholstered chair.

16. The fabric of claim 12, further comprising a concentration of binder fibers or powders serving as a bonding agent.

17. The flame blocking fabric of claim 16, wherein the concentration of binder fiber or powder is pre-treated with the flame retardant.

18. The flame blocking fabric of claim 12, wherein the individual fiber concentrations are pre-treated with the flame retardant.

19. The flame blocking fabric of claim 12, wherein the unbonded blended fiber concentrations is treated with the flame retardant.

20. The flame blocking fabric of claim 12, wherein the bonded non-woven fibrous web is-treated with the flame retardant.

21. The non-woven flame blocking fabric of claim 12, wherein the anti-skid treated non-woven calendared fabric forms a reinforced char barrier that is stronger than a charred non-woven highloft fabric.
